(19) United States
(12) Patent Application Publication
(10) Pub. No.: US 2012/0304701 A1
(43) Pub. Date: Dec. 6, 2012

(54) MANUFACTURING METHOD OF OPTICAL FIBER BASE MATERIAL POSSESSING LOW REFRACTIVE INDEX PORTION DISTANTLY-POSITIONED FROM CORE

(75) Inventor: Dai INOUE, Ibaraki (JP)

(73) Assignee: SHIN-ETSU CHEMICAL CO., LTD., Tokyo (JP)

(21) Appl. No.: 13/484,282

(22) Filed: May 31, 2012

(30) Foreign Application Priority Data
Jun. 3, 2011 (JP) 2011-125740

(51) Int. Cl. C03B 37/018

(52) U.S. Cl. 65/397

(57) ABSTRACT

Provided is a method for manufacturing an optical fiber base material, comprising manufacturing a soot deposition body having a core with a high refractive index at a center thereof, using VAD or OVD; dehydrating the soot deposition body within a heating furnace, with a temperature that does not vitrify the soot deposition body and in a helium atmosphere containing chlorine; after the dehydration, forming a core rod by vitrifying the soot deposition body at a temperature that vitrifies the soot deposition body, in a helium atmosphere; and applying cladding on the outside of the core rod. The helium atmosphere in the heating furnace when vitrifying the soot deposition body includes a gas containing a fluorine compound, and concentration of the fluorine in the atmospheric gas is in a range of 0.1 mol % to 10 mol %.

The contents of the following Japanese patent application are incorporated herein by reference: No. 2011-125740 filed on Jun. 3, 2011.

### BACKGROUND

1. Technical Field

The present invention relates to an optical fiber base material used mainly in communications, and particularly to a method for manufacturing an optical fiber base material having a low refractive index at a position distanced from the core. Specifically, the present invention relates to an optical fiber base material having a low refractive index at a position distanced from the core that is manufactured at low cost from an optical fiber base material having optical fiber characteristics of high bend strength and a small zero-dispersion wavelength, without having a decreased mode field diameter.

2. Related Art

Generally, optical fiber is made of a core that transmits light and a cladding that surrounds the core. The refractive index of the core is generally higher than the refractive index of the cladding. The optical fiber is obtained by heating and softening an optical fiber base material in an electric furnace and drawing the base material to a desired thickness.

The optical fiber base material is generally manufactured by, first, manufacturing a core rod that includes the core and, in certain cases, a portion of the cladding, and then applying cladding to the outside of the core rod.

When manufacturing the core rod, methods such as VAD, OVD, MCVD, and PCVD may be used. With VAD, the starting material is pulled while being rotated, and glass powder including SiO₂ as a main component, for example, is deposited near a tip thereof to form a soot deposition body. This glass powder is obtained, for example, by supplying hydrogen and oxygen to a burner to create an oxyhydrogen flame, supplying vaporized SiCl₄ serving as the raw material into the flame, and generating SiO₂ through the hydrolytic reaction. The soot deposition body is obtained by depositing the glass powder on a starting material.

For example, according to the ITU-T G.652 standard, a commonly used single-mode optical fiber having a rectangular refractive index distribution includes a portion with a high refractive index, referred to as the “core,” in a central region thereof. This core is often doped with GeO₂. For example, by doping SiCl₄ with GeCl₄, SiO₂ doped with GeO₂ can be generated, and the SiO₂ doped with GeO₂ is deposited to form the core. On the other hand, the practically flat portion of the refractive index distribution and surrounds the core is referred to as the “cladding.”

Generally, a refractive index distribution resembling the rectangular shape described above is obtained by preparing a plurality of burners, doping the central core with GeO₂, and supplying only SiO₂ to the outside of the core. A soot deposition body shaped as a pillar is manufactured in this way, and is then heated and melted in an electric furnace, referred to as a “sintering furnace,” to form a glass body shaped as a translucent rod. Helium is often used for the atmospheric gas in the electric furnace. This is because helium is a gas with small atoms, and makes it less likely that air bubbles will remain in the glass body.

At the same time as this vitrification, or before the vitrification, a dehydrating process is usually performed. The dehydration is performed in an atmosphere that includes chlorine, for example, and is performed at a temperature that is low enough that the soot deposition body does not melt and high enough that the moisture is sufficiently removed, e.g. a temperature from 1000° C. to 1200° C.

On the other hand, the vitrification is performed at a temperature from 1400° C. to 1600° C., for example. FIGS. 1A to 1C are schematic views of states in which vitrification is performed in a heating furnace. The vitrification is performed by passing a porous base material through a central heating furnace, beginning at the bottom end thereof, as shown by the progression from FIG. 1A to FIG. 1C. If a rod manufactured in this way is heated and melted as-is, an optical fiber with the necessary refractive index distribution can be obtained. However, since a high production rate is desired, cladding is usually applied to the outside to form a so-called core rod that is used when manufacturing a base material with a large diameter.

For example, when manufacturing a single-mode optical fiber base material using VAD, a core rod is manufactured that includes the core and a portion of the cladding surrounding the core, and the cladding that is still lacking is applied to the outside of the core rod by another means. The cladding applied to the outside may be applied by deposition directly on the core rod using OVD and then forming transparent glass through vitrification in a heating furnace, or by covering the core rod with a separately manufactured cylindrical body.

In recent years, the use of optical fiber has expanded to consumers and indoor wiring, and in this environment, the expected bend radius when the optical fiber is laid down is smaller than when the optical fiber covers a long distance. When optical fiber is bent, it becomes easier for the light propagated therein to leak out. Therefore, optical fiber is desired that has less light leakage for the same bend radius. Here, ITU-T G/657 is a standard dealing with this. The feature of having less light leakage for the same bend radius can be rephrased as having low bend loss, and in this specification is referred to as “bend strength.” There are many strategies known for obtaining an optical fiber with high bend strength.

First, there is a method of increasing the refractive index of the core to increase the light trapping effect. This method is the easiest way to obtain optical fiber with relatively high bend strength. However, increasing the refractive index decreases the mode field diameter and causes a large zero-dispersion wavelength, which is incompatible with ITU-T G.652, and does not fulfill a portion of the ITU-T G.657 standard.

Second, there is a method of providing a portion with a low refractive index (trench portion) at a position distanced from the core. The trench portion is usually rectangular, but the position, width, and depth of the trench portion can be adjusted to change the bend strength of the fiber. With this method, it is possible to obtain fiber with high bend strength, without decreasing the mode field diameter.

FIG. 2 shows a common rectangular refractive index distribution. FIG. 3 shows a trench-type refractive index distribution.

The trench portion is usually doped with fluorine to lower the refractive index thereof. However, the fluorine is easily dispersed during the optical fiber manufacturing process, particularly during the vitrification. Therefore, with methods such as VAD and OVD in which vitrification is performed after soot deposition, it is difficult to dope with fluorine during the soot deposition, such as when doping with GeO₂ during the core formation.

Accordingly, in order to manufacture an optical fiber base material having a trench portion using VAD or OVD, a three-step process is used that includes manufacturing a core rod that does not have a trench portion, forming a trench portion on the outside thereof, and finally forming a cladding on the outside thereof. In this case, an extra step is added, and therefore the three-step manufacturing methods end up increasing the manufacturing cost.

Third, there is a method of lowering the refractive index of the cladding portion around the core. This is referred to as a depressed refractive index distribution. FIG. 4 shows a depressed refractive index distribution.

As described above, when doping with fluorine during the soot deposition, the fluorine becomes easily dispersed, and therefore manufacturing is relatively simple with VAD and OVD. However, in this case, there is a problem that fluorine remains within the soot.

Therefore, a large amount of fluorine is necessary as a raw material to increase the bend strength of the optical fiber. At this time, the fluorine that does not remain in the soot is expelled as hydrogen fluoride. If the hydrogen fluorine concentration in the expelled gas is high, equipment must be provided to process and remove the fluorine gas. Furthermore, when a refractive index distribution with a deep depressed portion is used in an attempt to increase bend strength, the basic mode for propagating through the core becomes more likely to leak outside the fiber during propagation, and light cannot pas through the fiber.

Fourth, there is a method of opening a hole in the cladding to provide an air layer within the fiber. This is a modification of the second method, and the air layer effectively lowers the refractive index and provides a trench portion to achieve the light trapping effect, in the same manner as in the second method. With this method, it is necessary to open a hole in the optical fiber preform, and the process of opening the hole in the preform significantly reduces the production rate. Furthermore, the drawing must be performed slowly, and therefore high production rates cannot be expected.

Fifth, there is a method of providing a high refractive index portion in the cladding, and connecting a high-level mode with a cladding mode that is prone to leakage. To achieve this, a high-precision design is necessary, and high precision is also needed during manufacturing. Therefore, this method has an extremely high cost.

### SUMMARY

Therefore, it is an object of an aspect of the innovations herein to provide a an optical fiber base material having a low refractive index at a position distanced from the core, which is capable of overcoming the above drawbacks accompanying the related art. The above and other objects can be achieved by combinations described in the independent claims. According to a first aspect related to the innovations herein, provided is a method for manufacturing an optical fiber base material, comprising manufacturing a soot deposition body having a core with a high refractive index at a center thereof, using VAD or OVD; dehydrating the soot deposition body within a heating furnace, with a temperature that does not vitrify the soot deposition body and in a helium atmosphere containing chlorine; after the dehydration, forming a core rod by vitrifying the soot deposition body at a temperature that vitrifies the soot deposition body, in a helium atmosphere; and applying cladding on the outside of the core rod. The helium atmosphere in the heating furnace when vitrifying the soot deposition body includes a gas containing a fluorine compound, and concentration of the fluorine in the atmospheric gas is in a range of 0.1 mol % to 10 mol %.

Furthermore, average density of the soot deposition body is preferably no less than 0.21 g/cm³. The gas containing a fluorine compound comprises one of SiF₄, CF₄, C₂F₆, and SF₆.

The summary clause does not necessarily describe all necessary features of the embodiments of the present invention. The present invention may also be a sub-combination of the features described above.

### BRIEF DESCRIPTION OF THE DRAWINGS

FIG. 1A is a schematic view showing vitrification in a heating furnace.

FIG. 1B is a schematic view showing vitrification in a heating furnace.

FIG. 1C is a schematic view showing vitrification in a heating furnace.

FIG. 2 shows a common rectangular refractive index distribution.

FIG. 3 is a schematic view of a trench-type refractive index distribution.

FIG. 4 is a schematic view of a depressed refractive index distribution.

FIG. 5 shows the refractive index distribution of the optical fiber preform obtained according to an embodiment of the present invention.

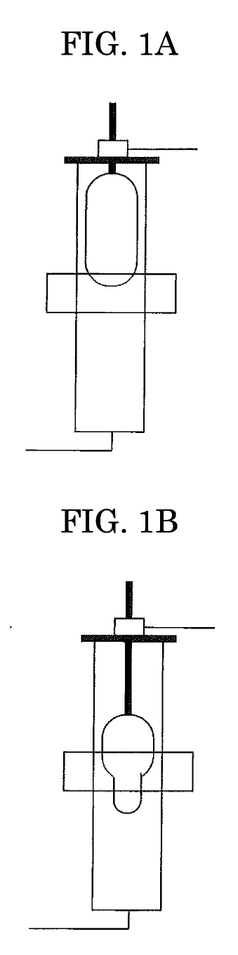

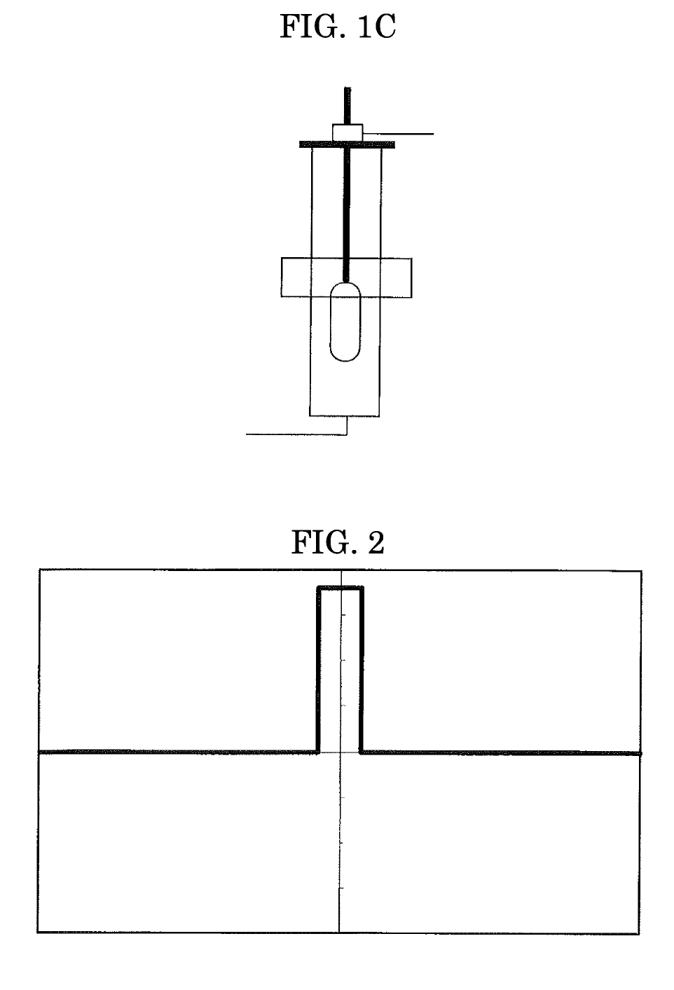

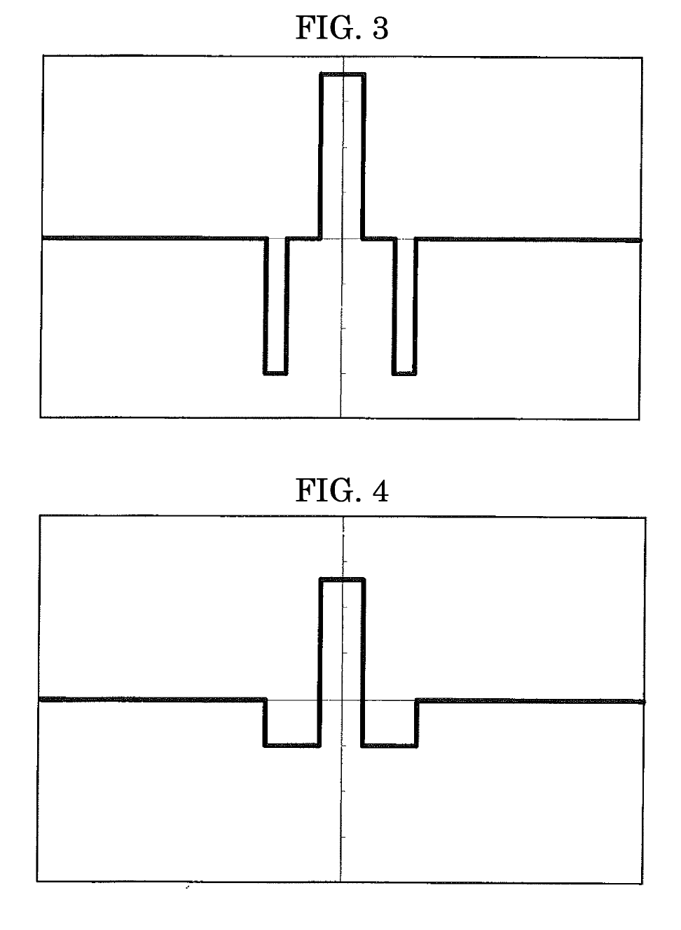

### DESCRIPTION OF EXEMPLARY EMBODIMENTS

Hereinafter, an embodiment of the present invention will be described. The embodiment does not limit the invention according to the claims, and all the combinations of the features described in the embodiment are not necessarily essential to means provided by aspects of the invention.

A fluorine doping method was investigated that includes, when vitrifying the soot deposition body, changing the concentration of a gas containing fluorine in an atmospheric gas, e.g. SiF₄, CF₄, SF₆, and C₂F₆, used for doping, and then performing vitrification to obtain a quartz glass rod. As a result, it was understood that, in accordance with the decrease in fluorine concentration, it became difficult to dope the fluorine uniformly in the quartz glass rod. Here, “not uniform” means that the fluorine gas is doped only near the outside of the resulting rod, and that inner portions of the rod are not doped with fluorine. In particular, it was understood that, when the density of the soot deposition body is greater than 0.21 g/cm³, the tendency of the fluorine to be doped only near the outside of the resulting rod and not be doped deeper within the rod is particularly strong.

When doping quartz glass with fluorine using this method, the decrease in the refractive index due to the fluorine in the quartz glass is proportional to ¼ the fluorine concentration in the atmospheric gas. However, when the fluorine concentration is less than 10 mol %, the fluorine is only doped near the outside, and the drop in refractive index relative to pure quartz in the portion with the lowest refractive index is proportional to the fluorine concentration raised to the ¼ power. When the soot deposition body is melted to form transparent glass, it is believed that the soot deposition body is vitrified while absorbing the fluorine in the atmospheric gas. However, in a case where the fluorine concentration is low, the fluorine gas near the outside of the rod is consumed, and the fluorine does not reach the inner region of the rod.

When cladding is applied using OVD or RIT to the outside of a core rod obtained in the above manner, the resulting optical fiber preform ultimately has a refractive index distribution with a trench portion. It should be noted that the trench portion has a well-known rectangular shape.

The depth of the trench portion is proportional to the fluorine concentration raised to the ¼ power, but when the fluorine concentration is 10 mol % or more, the fluorine becomes doped through the entire core rod and the trench portion is not formed, thereby resulting in a depressed refractive index distribution. Furthermore, when the fluorine concentration is less than 0.1 mol %, the trench portion is too shallow and the effect of controlling bending loss is not achieved.

### EMBODIMENTS

### Embodiment

A soot deposition body was manufactured, using VAD, to have an average density of 0.23 g/cm³, a core diameter and cladding diameter ratio of 0.27, and an outer diameter of 150 mm. This soot deposition body was inserted into a sintering furnace formed by an electric furnace and a quartz furnace tube, to be dehydrated at a temperature of 1100° C. while being supplied with He at 16 l/min, Cl₂ at 0.45 l/min, and O₂ at 0.01 l/min. After this, vitrification was performed at a temperature of 1480° C., while supplying He at 20 l/min and CF₄ at 0.03 l/min. The CF₄ is believed to break down at the high temperature of the furnace, and the fluorine concentration was approximately 0.6 mol %. As a result, the refractive index of the core was 0.40% greater than that of pure quartz, and the resulting core rod had an outer diameter of 65 mm and a cladding on the outside thereof with a refractive index that was 0.10% less than that of pure quartz.

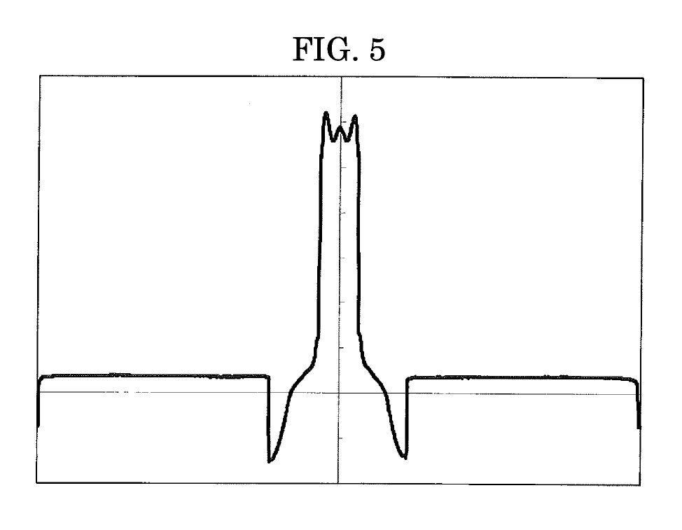

This core rod was heated and extended using a glass lathe including an oxyhydrogen burner, to obtain an outer diameter of 40 mm. Etching was then performed with an HF solution to obtain an outer diameter of 39 mm. The cladding was applied using OVD, to obtain a preform in which the ratio between the core rod diameter and the preform diameter was 0.235. FIG. 5 shows the refractive index distribution of the obtained preform.

The preform was drawn to obtain an optical fiber with a cutoff wavelength of 1310 nm, a mode field diameter of 8.8 μm, and a zero-dispersion wavelength of 1309 nm. The loss at 1550 nm when this optical fiber was wound once around a mandrel with a radius of 5 mm was 1.1 dB, and the loss at 1550 nm when this optical fiber was wound once around a mandrel with a radius of 7.5 mm was 0.2 dB. Furthermore, the transmission loss at 1310 nm, 1383 nm, and 1550 nm was respectively 0.331 dB/km, 0.289 dB/km, and 0.188 dB/km.

Only a small amount of CF₄ was used, and therefore the manufacturing cost is roughly the same as that of the normal optical fiber preform that is not doped with fluorine, as shown by the comparative example.

### Comparative Example

In the comparative example, an optical fiber was manufactured using the same method as in the above embodiment, except that the core rod was not doped with CF₄ during vitrification.

As a result, an optical fiber was obtained with a cutoff wavelength of 1310 nm, a mode field diameter of 8.8 μm, and a zero-dispersion wavelength of 1318 nm. The loss at 1550 nm when this optical fiber was wound once around a mandrel with a radius of 5 mm was 4 dB, and the loss at 1550 nm when this optical fiber was wound once around a mandrel with a radius of 7.5 mm was 0.5 dB. Furthermore, the transmission loss at 1310 nm, 1383 nm, and 1550 nm was respectively 0.330 dB/km, 0.295 dB/km, and 0.188 dB/km.

While the embodiment of the present invention has been described, the technical scope of the invention is not limited to the above described embodiment. It is apparent to persons skilled in the art that various alterations and improvements can be added to the above-described embodiment. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

As made clear from the above, the embodiment of the present invention can be used to obtain an optical fiber base material having a low refractive index at a position distanced from the core that has high bend strength and a small zero-dispersion wavelength and is manufactured at low cost, without having a decreased mode field diameter, by providing a trench portion at a position distanced from the core, according to a soot deposition body manufacturing method such as VAD or OVD.

What is claimed is:

1. A method for manufacturing an optical fiber base material, comprising:
manufacturing a soot deposition body having a core with a high refractive index at a center thereof, using VAD or OVD;
dehydrating the soot deposition body within a heating furnace, with a temperature that does not vitrify the soot deposition body and in a helium atmosphere containing chlorine;
after the dehydration, forming a core rod by vitrifying the soot deposition body at a temperature that vitrifies the soot deposition body, in a helium atmosphere; and
applying cladding on the outside of the core rod, wherein
the helium atmosphere in the heating furnace when vitrifying the soot deposition body includes a gas containing a fluorine compound, and
concentration of the fluorine in the atmospheric gas is in a range of 0.1 mol % to 10 mol %.

2. The method for manufacturing an optical fiber base material according to claim 1, wherein
average density of the soot deposition body is no less than 0.21 g/cm³.

3. The method for manufacturing an optical fiber base material according to claim 1, wherein
the gas containing a fluorine compound comprises one of SiF₄, CF₄, C₂F₆, and SF₆.
